(19) United States
(12) Patent Application Publication
(10) Pub. No.: US 2004/0104688 A1
(43) Pub. Date: Jun. 3, 2004

(54) Electron emitting method of electron emitter

(75) Inventors: Yukihisa Takeuchi, Nishikamo-gun (JP); Tsutomu Nanataki, Toyoake-city (JP); Iwao Ohwada, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/405,990

(22) Filed: Apr. 2, 2003

(30) Foreign Application Priority Data
Nov. 29, 2002 (JP) 2002-348916

(51) Int. Cl. G09G 3/10

(52) U.S. Cl. 315/169.4

(57) ABSTRACT

An electron emitter has an electric field receiving member formed on a substrate, and a cathode electrode and an anode electrode formed on a same surface of the electric field receiving member. A slit is formed between the cathode electrode and the anode electrode. The cathode electrode is supplied with a drive signal from a pulse generation source, and the anode electrode is connected to an anode potential generation source (GND in this example). A collector electrode is provided above the electric field receiving member at a position facing the slit. The collector electrode is connected to a collector potential generation source (Vc in this example) through a resistor. The electric field receiving member is made of a piezoelectric material.

### BACKGROUND OF THE INVENTION

1. Field of the Invention

The present invention relates to a method of emitting electrons from an electron emitter having an anode electrode and a cathode electrode formed on an electric field receiving member.

2. Description of the Related Art

In recent years, electron emitters having a cathode electrode and an anode electrode have been used in various applications such as field emission displays (FEDs) and backlight units. In an FED, a plurality of electron emitters are arranged in a two-dimensional array, and a plurality of fluorescent elements are positioned at predetermined intervals in association with the respective electron emitters.

Conventional electron emitters are disclosed in Japanese laid-open patent publication No. 1-311533, Japanese laid-open patent publication No. 7-147131, Japanese laid-open patent publication No. 2000-285801, Japanese patent publication No. 46-20944, and Japanese patent publication No. 44-26125, for example. All of these disclosed electron emitters are disadvantageous in that since no dielectric body is employed in the electric field receiving member, a forming process or a micromachining process is required between facing electrodes, a high voltage needs to be applied between the electrodes to emit electrons, and a panel fabrication process is complex and entails a high panel fabrication cost.

It has been considered to make an electric field receiving member of a dielectric material. Various theories about the emission of electrons from a dielectric material have been presented in the documents: Yasuoka and Ishii, “Pulsed electron source using a ferroelectric cathode”, J. Appl. Phys., Vol. 68, No. 5, p. 546-550 (1999), V. F. Puchkarev, G. A. Mesyats, “On the mechanism of emission from the ferroelectric ceramic cathode”, J. Appl. Phys., Vol. 78, No. 9, 1 Nov. 1995, p. 5633-5637, and H. Riege, “Electron emission ferroelectrics—a review”, Nucl. Instr. and Meth. A340, p. 80-89 (1994). However, the principles behind an emission of electrons have not yet been established, and advantages of an electron emitter having an electric field receiving member made of a dielectric material have not been achieved.

In particular, the difference of electron emission characteristics depending on the field receiving member formed of different materials, such as piezoelectric materials, anti-ferroelectric materials, and electrostrictive materials has not yet been researched.

### SUMMARY OF THE INVENTION

It is an object of the present invention to provide a method of emitting electrons from an electron emitter having an electric field receiving member made of a piezoelectric material in which the electron emitter emits electrons efficiently, and can be utilized easily in displays or light sources.

Another object of the present invention is to provide a method of emitting electrons from an electron emitter having an electric field receiving member made of an anti-ferroelectric material in which the electron emitter emits electrons efficiently, and can be utilized easily in displays or light sources.

Another object of the present invention is to provide a method of emitting electrons from an electron emitter having an electric field receiving member made of an electrostrictive material in which the electron emitter emits electrons efficiently, and can be utilized easily in displays or light sources.

The present invention provides a method of emitting electrons from an electron emitter including an electric field receiving member made of a piezoelectric material, a cathode electrode in contact with the electric field receiving member, and an anode electrode in contact with the electric field receiving member, the method comprising the steps of:

polarizing the electric field receiving member in one direction; and

applying an electric field beyond a coercive field rapidly to the electric field receiving member to reverse polarization of the electric field receiving member for emitting electrons. In the method, the electric field beyond the coercive field may be applied to the electric field within a certain period for emitting electrons.

Thus, a voltage having a level for polarizing the electric field receiving member is applied between the cathode electrode and the anode electrode. Thereafter, a voltage having a level of reversing the polarization of the electric field receiving member is applied between the cathode electrode and the anode electrode. Consequently, electrons are emitted from the electric field concentration point (triple point of the cathode electrode, the electric field receiving member, and the vacuum) on the side of the cathode electrode. If the cathode electrode is very thin, having a thickness of 10 nm or less, electrons are emitted from the interface between the cathode electrode and the electric field receiving member.

In particular, the electric field beyond the level of the coercive field is rapidly applied to the electric field receiving member which is polarized in one direction. Therefore, the electrons are emitted efficiently, and the electron emitter can be utilized easily in displays or light sources.

The electric field for inducing electron emission is beyond the level of the coercive field. In the electric field for electron emission, the polarization reversal is almost completed. The levels of the electric fields do not change substantially. Therefore, the electron emitter has digital-like electron emission characteristics. The level of the electric field for electron emission depends on the coercive field. When the level of the coercive field is small, the electron emitter can be operated at a low voltage.

According to the present invention, the polarization of the electric field receiving member in one direction may be performed by applying a voltage between the cathode electrode and the anode electrode for causing the cathode electrode to have a positive potential (positive voltage) in a first period, and

the polarization reversal of the electric field receiving member for emitting electrons may be performed by applying a voltage between the cathode electrode and the anode electrode for causing cathode electrode to have a negative potential (negative voltage) in a second period.

The level of the negative voltage may be controlled so that the electric field beyond the coercive field is applied to the electric field for emitting electrons within a certain period from the beginning of the second period. In this case, the level of the negative voltage may be controlled by controlling the pulse drive signal. Specifically, if the drive signal has a pulse waveform having a falling edge (ramp), for example, the maximum amplitude or a transition time (a period from the beginning of the second period until the voltage reaches the maximum amplitude) is controlled, and if the drive signal has a rectangular pulse waveform, only the maximum amplitude is controlled. The certain period should be as small as possible for efficiently emitting electrons. Preferably, the certain period is 1 μsec or less, and more preferably, the certain period is 10 μsec or less.

Further, the present invention provides a method of emitting electrons from an electron emitter including an electric field receiving member made of an anti-ferroelectric material, a cathode electrode in contact with the electric field receiving member, and an anode electrode in contact with the electric field receiving member, the method comprising the step of:

applying an electric field to the electric field receiving member to induce phase transition of the electric field receiving member into a ferroelectric material, and polarize the electric field receiving member for emitting electrons.

The electric field applied to the electric field receiving member may have a level for inducing phase transition of the electric field receiving member within a certain period, and polarizing the electric field receiving member for emitting electrons.

A voltage applied between the cathode electrode and the anode electrode initially has a level in which polarization of the electric field receiving member does not occur. Thereafter, a voltage applied between the cathode electrode and the anode electrode subsequently has a level in which polarization of the electric field receiving member occurs. Thus, electrons are emitted from an electric field concentration point on the side of the cathode electrode. If the cathode electrode is very thin, having a thickness of 10 nm or less, electrons are emitted from the interface between the cathode electrode and the electric field receiving member.

The electric field is applied to the electric field receiving member rapidly for inducing phase transition in the electric field receiving member into a ferroelectric material and polarization of the electric field receiving member. Therefore, the electrons are emitted efficiently, and the electron emitter can be utilized easily in displays or light sources.

In the electric field for inducing electron emission, polarization or polarization reversal is almost completed. The levels of the electric fields do not change substantially. Therefore, the electron emitter has digital-like electron emission characteristics. The electric field for electron emission depends on the electric field for inducing phase transition of the electric field receiving member into the ferroelectric material. When the level of the electric field for inducing phase transition is small, the electron emitter is operated at a low voltage.

In the present invention, for example, phase transition of the electric field receiving member is induced, and the electric field receiving member is polarized for emitting electrons by the steps of:

applying a reference voltage between the cathode electrode and the anode electrode in a first period; and

applying a voltage rapidly between the cathode electrode and the anode electrode to cause the cathode electrode to have a negative potential (negative voltage) in a second period.

In the electron emission method, when the reference voltage is 0V, the polarization of the electric field receiving member in the first period is reset. Electron emission in the second period can be carried out by the single polarity operation (negative polarity). Thus, the driving circuit system is simplified. The electron emitter can be operated by small energy consumption at a low cost with a compact structure.

The level of the negative voltage may be controlled so that phase transition of the electric field receiving member is induced within a certain period from the beginning of the second period, and the electric field receiving member is polarized for emitting electrons.

In the second period, the level of the negative voltage applied at the beginning of the second period may be controlled by controlling the pulse drive signal. Specifically, if the drive signal has a pulse waveform having a falling edge (ramp), for example, the maximum amplitude or a transition time is controlled, and if the drive signal has a rectangular pulse waveform, only the maximum amplitude is controlled. The certain period should be as small as possible for efficiently emitting electrons. Preferably, the certain period is 10 μsec or less, and more preferably, the certain period is 10 μsec or less.

The level of the negative voltage may be controlled to repeat a series of cycle in which the voltage between the electrode and the anode electrode reaches a level required for electron emission and the voltage between the cathode electrode and the anode electrode drops due to electron emission to a threshold level for resetting polarization of the electric field receiving member.

When the phase transition from the anti-ferroelectric material to the ferroelectric material occurs, the difference between the voltage level for inducing electron emission and the voltage level (threshold level) for resetting polarization is small. Therefore, when electron emission occurs to cause the voltage drop between the cathode electrode and the anode electrode, the polarization in the electric field receiving member is reset easily, and the electric field receiving member is brought into a condition as if the electric field receiving member were in the first period (a condition in which the reference voltage is applied).

In the second period, since the negative voltage is applied to the cathode electrode, the voltage between the cathode electrode and the anode electrode rapidly reaches the voltage level required for electron emission, and the electron emission starts to occur.

Therefore, by controlling the level of the negative voltage in the second period, the above sequential operation is repeated successively.

Further, the present invention provides a method of emitting electrons from an electron emitter including an electric field receiving member made of an electrostrictive material, a cathode electrode in contact with the electric field receiving member, and an anode electrode in contact with the electric field receiving member, the method comprising the step of:

applying an electric field to the electric field receiving member to control the amount of polarization of the electric field receiving member for emitting electrons.

A voltage applied between the cathode electrode and the anode electrode initially has a level in which polarization of the electric field receiving member does not occur. Thereafter, a voltage applied between the cathode electrode and the anode electrode subsequently has a level in which polarization of the electric field receiving member occurs. Thus, electrons are emitted from an electric field concentration point on the side of the cathode electrode. If the cathode electrode is very thin, having a thickness of 10 nm or less, electrons are emitted from the interface between the cathode electrode and the electric field receiving member.

In the electron emission method, the electric field receiving member is polarized gradually according to the change of the electric field. When the amount of polarization per unit time is large (when the change of the electric field within a certain period is large), the number of emitted electrons is large.

The number of emitted electrons depends on the intensity in the electric field to some extent. However, the number of emitted electrons depends more largely depends on the change in the intensity of the electric field. As long as the change in the intensity of the electric field is large, even if the electric field is small, the number of emitted electrons is large. Therefore, the electron emitter has analog-like electron emission characteristics. As described above, when the change in the intensity of the electric field per unit time (the rate of change in the polarization per unit time) is large, the intensity of the electric field can be small. Therefore, the electron emitter can be operated at a low voltage.

The rate of change in the electric field applied to the electric field receiving member per unit time is controlled for controlling the amount of polarization in the electric field receiving member. Therefore, the electrons are emitted efficiently, and the electron emitter can be utilized easily in displays or light sources.

In the present invention, for example, the electric field receiving member is polarized for emitting electrons by the steps of:

applying a reference voltage between the cathode electrode and the anode electrode in a first period; and

applying a voltage rapidly between the cathode electrode and the anode electrode to cause the cathode electrode. to have a negative potential (negative voltage) in a second period.

In the electron emission method, when the reference voltage is 0V, the polarization of the electric field receiving member in the first period is reset. Electron emission in the second period can be carried out by the single polarity operation (negative polarity). Thus, the driving circuit system is simplified. The electron emitter can be operated by small energy consumption at a low cost with a compact structure.

The level of the negative voltage may be controlled so that an amount of polarization in the electric field receiving member within a certain period from the beginning of the second period is controlled, and the number of emitted electrons is controlled.

The level of the negative voltage may be controlled by controlling the pulse drive signal. Specifically, if the drive signal has a pulse waveform having a falling edge (ramp), for example, the maximum amplitude or a transition time is controlled, and if the drive signal has a rectangular pulse waveform, only the maximum amplitude is controlled. Preferably, the certain period is 10 μsec or less, and more preferably, the certain period is 10 μsec or less.

The level of the negative voltage may be controlled applied at the beginning of the second period so that electron emission continues after the electron emission by slight fluctuation of the voltage between the cathode electrode and the anode electrode.

The electric field receiving member is polarized gradually according to the change of the electric field. When the amount of polarization per unit time is large (when the change of the electric field within the certain period is large), the number of emitted electrons is large. The difference between the voltage level for inducing electron emission and the voltage level (threshold level) for resetting polarization is small.

Therefore, when electron emission occurs to cause the voltage drop between the cathode electrode and the anode electrode, the polarization in the electric field receiving member is reset easily, and the electric field receiving member is brought into a condition as if the electric field receiving member were in the first period (a condition in which the reference voltage is applied).

In the second period, the negative voltage is applied to the cathode electrode. Therefore, the voltage between the cathode electrode and the anode electrode is increased rapidly. At this time, the change in the polarization progresses rapidly. Thus, electrons are emitted at a voltage lower than the voltage for the first electron emission.

After the second electron emission to cause the voltage drop between the cathode electrode and the anode electrode, the polarization of the electric field receiving member is reset again easily. Thereafter, by continuously applying the negative voltage to the cathode electrode, the voltage between the cathode electrode and the anode electrode is increased again to polarize the electric field receiving member. Again, the change in the polarization progresses rapidly, and the electron emission occurs at a voltage substantially same as the voltage for the second electron emission.

By controlling the level of the negative voltage in the second period, the voltage between the cathode electrode and the anode electrode fluctuates slightly. The slight fluctuation keeps the electron emission.

The above and other objects, features, and advantages of the present invention will become more apparent from the following description of preferred embodiments when taken in conjunction with the accompanying drawings.

### BRIEF DESCRIPTION OF THE DRAWINGS

FIG. 1 is a view showing an electron emitter according to an embodiment of the present invention (an electron emitter according to first through third specific examples);

FIG. 2 is a plan view showing electrodes of the electron emitter according to the embodiment of the present invention;

FIG. 3 is a waveform diagram showing a drive signal outputted from a pulse generation source;

FIG. 4 is a view illustrative of operation when a positive voltage is applied to a cathode electrode;

FIG. 5A is a view illustrative of operation of ionization when a negative voltage is applied to the cathode electrode;

FIG. 5B is a view illustrative of operation of emission of secondary electrons when a negative voltage is applied to the cathode electrode;

FIG. 6 is a view showing a polarization-electric field characteristic curve of a piezoelectric material;

FIG. 7 is a waveform diagram showing changes in the drive signal supplied to the cathode electrode, a collector current flowing through a collector electrode, and a voltage applied between the cathode/electrode and the anode electrode in an electron emitter according to the first specific example;

FIG. 8A is a waveform diagram showing an example (rectangular pulse waveform) of the drive signal;

FIG. 8B is a waveform diagram showing another example (pulse waveform having a ramp falling edge) of the drive signal;

FIG. 9 is a view showing a polarization-electric field characteristic curve of an anti-ferroelectric material;

FIG. 10 is a waveform diagram showing changes in the drive signal supplied to the cathode electrode, a collector current flowing the collector electrode, and the voltage applied between the cathode electrode and the anode electrode in an electron emitter according to the second specific example;

FIG. 11 is a view showing a polarization-electric field characteristic curve of an electrostrictive material; and

FIG. 12 is a waveform diagram showing changes in the drive signal supplied to the cathode electrode, a collector current flowing the collector electrode, and the voltage applied between the cathode electrode and the anode electrode in an electron emitter according to the third specific example.

### DESCRIPTION OF THE PREFERRED EMBODIMENTS

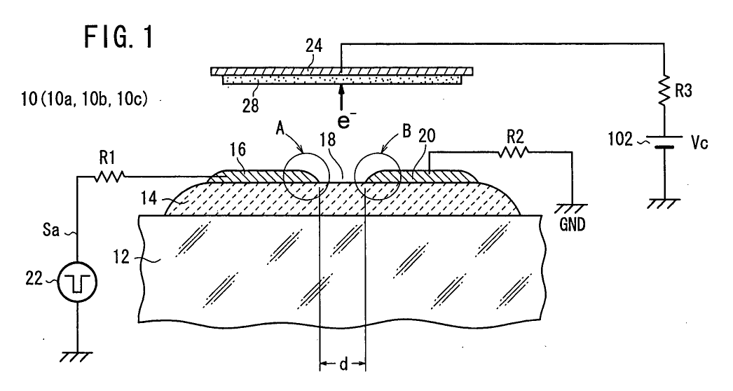

Methods of emitting electrons from electron emitters according to embodiments of the present invention will be described below with reference to FIGS. 1 through 12.

Generally, the electron emitters can be used in displays, electron beam irradiation apparatus, light sources, alternatives to LEDs, and apparatus for manufacturing electronic parts.

Electron beams in electron beam irradiation apparatus have a high energy and a good absorption capability in comparison with ultraviolet rays in ultraviolet ray irradiation apparatus that are presently in widespread use. The electron emitters are used to solidify insulating films in superposing wafers for semiconductor devices, harden printing inks without irregularities for drying prints, and sterilize medical devices while being kept in packages.

The electron emitters are also used as high-luminance, high-efficiency light sources for use in projectors, for example.

The electron emitters are also used as alternatives to LEDs in chip light sources, traffic signal devices, and backlight units for small-size liquid-crystal display devices for cellular phones.

The electron emitters are also used in apparatus for manufacturing electronic parts, including electron beam sources for film growing apparatus such as electron beam evaporation apparatus, electron sources for generating a plasma (to activate a gas or the like) in plasma CVD apparatus, and electron sources for decomposing gases.

The electron emitters are also used as vacuum micro devices such as ultra-high speed devices operated at a frequency on the order of Tera-Hz, and environment adaptive electronic parts used in a wide temperature range.

The electron emitters are also used as electronic circuit devices including digital devices such as switches, relays, and diodes, and analog devices such as operational amplifiers. The electron emitters are used for realizing a large current output, and a high amplification ratio.

As shown in FIG. 1, an electron emitter 10 according to the embodiment of the present invention has an electric field receiving member 14 formed on a substrate 12, a cathode electrode 16 and an anode electrode 20 formed on one surface of the electric field receiving member 14. A slit 18 is formed between the cathode electrode 16 and the anode electrode 20. The cathode electrode 16 is supplied with a drive signal Sa from a pulse generation source 22 through a resistor R1, and the anode electrode 20 is connected to an anode potential generation source (GND in this example) through a resistor R2.

For using the electron emitter 10 according to the embodiment of the present invention as a pixel of a display, a collector electrode 24 is provided above the electric field receiving member 14 at a position facing the slit 18, and the collector electrode 24 is coated with a fluorescent layer 28. The collector electrode 24 is connected to a collector potential generation source 102 (Vc in this example) through a resistor R3.

The electron emitter 10 according to the embodiment of the present invention is placed in a vacuum space. As shown in FIG. 1, the electron emitter 10 has electric field concentration points A and B. The point A can be defined as a triple point where the cathode electrode 16, the electric field receiving member 14, and the vacuum are present at one point. The point B can be defined as a triple point where the anode electrode 20, the electric field receiving member 14, and the vacuum are present at one point.

The vacuum level in the atmosphere is preferably in the range from 10² to 10⁻⁶ Pa and more preferably in the range from 10⁻³ to 10⁻⁵ Pa.

The range of the vacuum level is determined for the following reason. In a lower vacuum, many gas molecules would be present in the space, and (1) a plasma can easily be generated and, if the plasma were generated excessively, many positive ions would impinge upon the cathode electrode 16 and damage the cathode electrode 16, and (2) emitted electrons would impinge upon gas molecules prior to arrival at the collector electrode 24, failing to sufficiently excite the fluorescent layer 28 with electrons that are sufficiently accelerated by the collector potential (Vss).

In a higher vacuum, though electrons are smoothly emitted from the electric field concentration points A and B, (1) gas molecules would be insufficient to generate a plasma, and (2) structural body supports and vacuum seals would be large in size, posing difficulty in making a small electron emitter.

The electric field receiving member 14 is made of a dielectric material. The dielectric material should preferably have a high relative dielectric constant (relative permittivity), e.g., a dielectric constant of 1000 or higher. Dielectric materials of such a nature may be ceramics including barium titanate, lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstenate, lead cobalt niobate, etc. or a material whose principal component contains 50 weight % or more of the above compounds, or such ceramics to which there is added an oxide of lanthanum, calcium, strontium, molybdenum, tungsten, barium, niobium, zinc, nickel, manganese, or the like, or a combination of these materials, or any of other compounds.

For example, a two-component material nPMN-mPT (n, m represent molar ratios) of lead magnesium niobate (PMN) and lead titanate (PT) has its Curie point lowered for a larger relative dielectric constant at room temperature if the molar ratio of PMN is increased.

Particularly, a dielectric material where n=0.85-1.0 and m=1.0-n is preferable because its relative dielectric constant is 3000 or higher. For example, a dielectric material where n=0.91 and m=0.09 has a relative dielectric constant of 15000 at room temperature, and a dielectric material where n=0.95 and m=0.05 has a relative dielectric constant of 20000 at room temperature.

For increasing the relative dielectric constant of a three-component dielectric material of lead magnesium niobate (PMN), lead titanate (PT), and lead zirconate (PZ), it is preferable to achieve a composition close to a morphotropic phase boundary (MPB) between a tetragonal system and a quasi-cubic system or a tetragonal system and a rhombohedral system, as well as to increase the molar ratio of PMN. For example, a dielectric material where PMN:PT:PZ=0.375:0.375:0.25 has a relative dielectric constant of 5500, and a dielectric material where PMN:PT:PZ=0.5:0.375:0.125 has a relative dielectric constant of 4500, which is particularly preferable. Furthermore, it is preferable to increase the dielectric constant by introducing a metal such as platinum into these dielectric materials within a range to keep them insulative. For example, a dielectric material may be mixed with 20 weight % of platinum.

As described above, the electric field receiving member 14 may be formed of a piezoelectric/electrostrictive layer or an anti-ferroelectric layer. If the electric field receiving member 14 is a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstenate, lead cobalt niobate, or the like, or a combination of any of these materials.

The electric field receiving member 14 may be made of chief components including 50 weight % or more of any of the above compounds. Of the above ceramics, the ceramics including lead zirconate is most frequently used as a constituent of the piezoelectric/electrostrictive layer of the electric field receiving member 14.

If the piezoelectric/electrostrictive layer is made of ceramics, then oxides of lanthanum, calcium, strontium, molybdenum, tungsten, barium, niobium, zinc, nickel, manganese, or the like, or a combination of these materials, or any of other compounds may be added to the ceramics.

For example, the piezoelectric/electrostrictive layer should preferably be made of ceramics including as chief components lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the electric field receiving member 14 is formed of an anti-ferroelectric layer, then the anti-ferroelectric layer may be made of lead zirconate as a chief component, lead zirconate and lead stannate as chief components, lead zirconate with lanthanum oxide added thereto, or lead zirconate and lead stannate as components with lead zirconate and lead niobate added thereto.

The anti-ferroelectric layer may be porous. If the anti-ferroelectric layer is porous, then it should preferably have a porosity of 30% or less.

The electric field receiving member 14 may be formed on the substrate 12 by any of various thick-film forming processes including screen printing, dipping, coating, electrophoresis, etc., or any of various thin-film forming processes including an ion beam process, sputtering, vacuum evaporation, ion plating, chemical vapor deposition (CVD), plating, etc.

In the embodiment, the electric field receiving member 14 is formed on the substrate 12 suitably by any of various thick-film forming processes including screen printing, dipping, coating, electrophoresis, etc.

These thick-film forming processes are capable of providing good piezoelectric operating characteristics as the electric field receiving member 14 can be formed using a paste, a slurry, a suspension, an emulsion, a sol, or the like which is chiefly made of piezoelectric ceramic particles having an average particle diameter ranging from 0.01 to 5 μm, preferably from 0.05 to 3 μm.

In particular, electrophoresis is capable of forming a film at a high density with high shape accuracy, and has features described in technical documents such as “Electrochemistry Vol. 53. No. 1 (1985), p. 63-68, written by Kazuo Anzai”, and “The 1^{st} Meeting on Finely Controlled Forming of Ceramics Using Electrophoretic Deposition Method, Proceedings (1998), p. 5-6, p. 23-24”. Any of the above processes may be chosen in view of the required accuracy and reliability.

The width d of the slit 18 between the cathode electrode 16 and the anode electrode 20 is determined so that polarization reversal occurs in the electric field E represented by E=V/d (V is a voltage applied between the electrodes 16 and 20). When the width d of the slit 18 is small, the polarization reversal occurs at a low voltage, and electrons are emitted at the low voltage (e.g., less than 100V).

The cathode electrode 16 is made of materials described below. The cathode electrode 16 should preferably be made of a conductor having a small sputtering yield and a high evaporation temperature in vacuum. For example, materials having a sputtering yield of 2.0 or less at 600 V in Ar⁺ and an evaporation pressure of 1.3×10⁻³ Pa at a temperature of 1800 K or higher are preferable. Such materials include platinum, molybdenum, tungsten, etc. Further, the cathode electrode 16 is made of a conductor which is resistant to a high-temperature oxidizing atmosphere, e.g., a metal, an alloy, a mixture of insulative ceramics and a metal, or a mixture of insulative ceramics and an alloy. Preferably, the cathode electrode 16 should be composed chiefly of a precious metal having a high melting point, e.g., platinum, palladium, rhodium, molybdenum, or the like, or an alloy of silver and palladium, silver and platinum, platinum and palladium, or the like, or a cermet of platinum and ceramics. Further preferably, the cathode electrode 16 should be made of platinum only or a material composed chiefly of a platinum-base alloy. The electrode should preferably be made of carbon or a graphite-base material, e.g., diamond thin film, diamond-like carbon, or carbon nanotube. Ceramics to be added to the electrode material should preferably have a proportion ranging from 5 to 30 volume %.

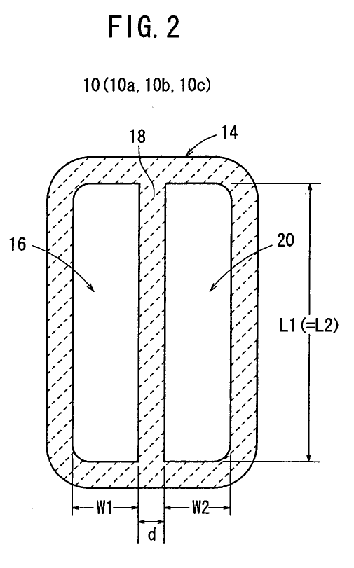

The cathode electrode 16 may be made of any of the above materials by an ordinary film forming process which may be any of various thick-film forming processes including screen printing, spray coating, dipping, coating, electrophoresis, etc., or any of various thin-film forming processes including sputtering, an ion beam process, vacuum evaporation, ion plating, CVD, plating, etc. Preferably, the cathode electrode 16 is made by any of the above thick-film forming processes. Dimensions of the cathode electrode 16 will be described with reference to FIG. 2. In FIG. 2, the cathode electrode 16 has a width W1 of 2 mm, and a length L1 of 5 mm. Preferably, the cathode electrode 16 has a thickness of 20 μm or less, or more preferably 5 μm or less.

The anode electrode 20 is made of the same material by the same process as the cathode electrode 16. Preferably, the anode electrode 20 is made by any of the above thick-film forming processes. Preferably, the anode electrode 20 has a thickness of 20 μm or less, or more preferably 5 μm or less. In FIG. 2, the anode electrode 20 has a width W2 of 2 mm, and a length L2 of 5 mm as with the cathode electrode 16.

In the embodiment of the present invention, the width d of the slit between the cathode electrode and the anode electrode is 70 μm.

The substrate 12 should preferably be made of an electrically insulative material in order to electrically isolate the line electrically connected to the cathode electrode 16 and the line electrically connected to the anode electrode 20 from each other.

Thus, the substrate 12 may be made of a highly heat-resistant metal or a metal material such as an enameled metal whose surface is coated with a ceramic material such as glass or the like. However, the substrate 12 should preferably be made of ceramics.

Ceramics which the substrate 12 is made of include stabilized zirconium oxide, aluminum oxide, magnesium oxide, titanium oxide, spinel, mullite, aluminum nitride, silicon nitride, glass, or a mixture thereof. Of these ceramics, aluminum oxide or stabilized zirconium oxide is preferable from the standpoint of strength and rigidity. Stabilized zirconium oxide is particularly preferable because its mechanical strength is relatively high, its tenacity is relatively high, and its chemical reaction with the cathode electrode 16 and the anode electrode 20 is relatively small. Stabilized zirconium oxide includes stabilized zirconium oxide and partially stabilized zirconium oxide. Stabilized zirconium oxide does not develop a phase transition as it has a crystalline structure such as a cubic system.

Zirconium oxide develops a phase transition between a monoclinic system and a tetragonal system at about 1000° C. and is liable to suffer cracking upon such a phase transition. Stabilized zirconium oxide contains 1 to 30 mol % of a stabilizer such as calcium oxide, magnesium oxide, yttrium oxide, scandium oxide, ytterbium oxide, cerium oxide, or an oxide of a rare earth metal. For increasing the mechanical strength of the substrate 12, the stabilizer should preferably contain yttrium oxide. The stabilizer should preferably contain 1.5 to 6 mol % of yttrium oxide, or more preferably 2 to 4 mol % of yttrium oxide, and furthermore should preferably contain 0.1 to 5 mol % of aluminum oxide.

The crystalline phase may be a mixed phase of a cubic system and a monoclinic system, a mixed phase of a tetragonal system and a monoclinic system, a mixed phase of a cubic system, a tetragonal system, and a monoclinic system, or the like. The main crystalline phase which is a tetragonal system or a mixed phase of a tetragonal system and a cubic system is optimum from the standpoints of strength, tenacity, and durability.

If the substrate 12 is made of ceramics, then the substrate 12 is made up of a relatively large number of crystalline particles. For increasing the mechanical strength of the substrate 12, the crystalline particles should preferably have an average particle diameter ranging from 0.05 to 2 μm, or more preferably from 0.1 to 1 μm.

Each time the electric field receiving member 14, the cathode electrode 16, or the anode electrode 20 is formed, the assembly is heated (sintered) into a structure integral with the substrate 12. After the electric field receiving member 14, the cathode electrode 16, and the anode electrode 20 are formed, they may simultaneously be sintered so that they may simultaneously be integrally coupled to the substrate 12. Depending on the process by which the cathode electrode 16 and the anode electrode 20 are formed, they may not be heated (sintered) so as to be integrally combined with the substrate 12.

The sintering process for integrally combining the substrate 12, the electric field receiving member 14, the cathode electrode 16, and the anode electrode 20 may be carried out at a temperature ranging from 500 to 1400° C. preferably from 1000 to 1400° C. For heating the electric field receiving member 14 which is in the form of a film, the electric field receiving member 14 should be sintered together with its evaporation source while their atmosphere is being controlled.

The electric field receiving member 14 may be covered with an appropriate member for preventing the surface thereof from being directly exposed to the sintering atmosphere when the electric field receiving member 14 is sintered. The covering member should preferably be made of the same material as the substrate 12.

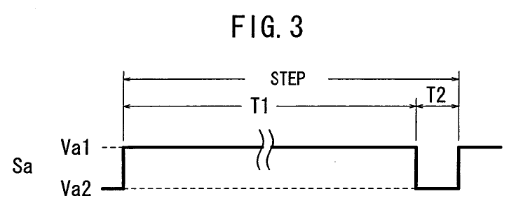

The principles of electron emission of the electron emitter 10 will be described below with reference to FIGS. 1 through 5B. As shown in FIG. 3, the drive signal Sa outputted from the pulse generation source 22 has repeated steps each including a period in which a positive voltage Va1 (or a reference voltage) is outputted (preparatory period T1) and a period in which a negative voltage Va2 is outputted (electron emission period T2). The drive signal has a rectangular pulse waveform indicating a positive voltage in the preparatory period and a negative voltage in the electron emission period.

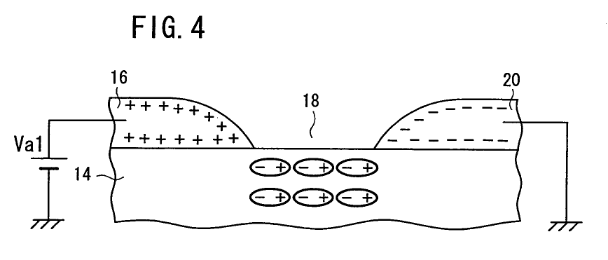

The preparatory period T1 is a period in which the positive voltage Va1 is applied to the cathode electrode 16 to polarize the electric field receiving member 14, as shown in FIG. 4. The positive voltage Va1 may be a DC voltage, as shown in FIG. 3, but may be a single pulse voltage or a succession of pulse voltages.

The voltage levels of the positive voltage Va1 and the negative voltage Va2 are determined so that the polarization to the positive polarity and the negative polarity can be performed reliably. For example, if the dielectric material of the electric field receiving member 14 has a coercive voltage, preferably, the absolute values of the positive voltage Va1 and the negative voltage Va2 are the coercive voltage or higher.

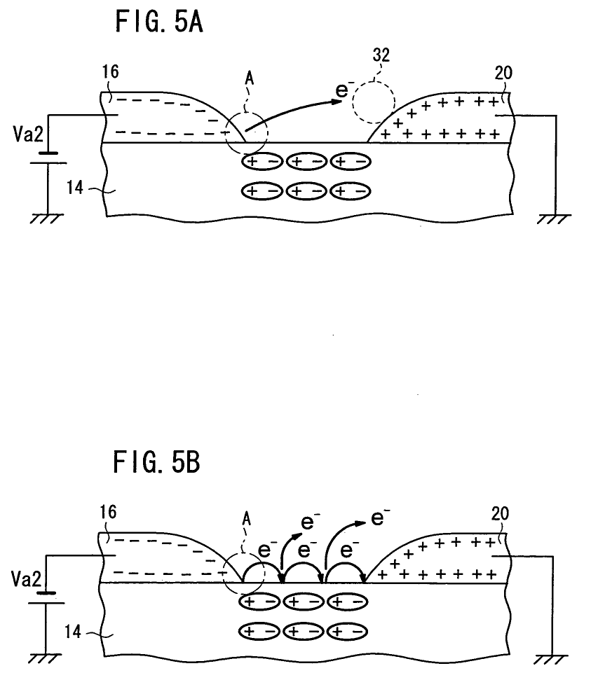

The electron emission period T2 is a period in which the negative voltage Va2 is applied to the cathode electrode 16. When the negative voltage Va2 is applied to the cathode electrode 16, as shown in FIGS. 5A and 5B, the polarization of the electric field receiving member 14 is reversed, causing electrons to be emitted from the electric field concentration point A. If the cathode electrode 16 is very thin, having a thickness of 10 nm or less, electrons are emitted from the interface between the cathode electrode 16 and the electric field receiving member 14.

Specifically, dipole moments are charged in the interface between the electric field receiving member 14 whose polarization has been reversed and the cathode electrode 16 to which the negative voltage Va2 is applied. Electrons are emitted when the direction of these dipole moments is changed. The electrons are considered to include primary electrons emitted from the cathode electrode 16 in a local concentrated electric field developed between the cathode electrode 16 and the positive poles of the dipole moments near the cathode electrode 16, and secondary electrons emitted from the electric field receiving member 14 upon collision of the primary electrons with the electric field receiving member 14. The electron emission period T2 should preferably be in the range from 1 to 10 μsec.

Some of the emitted electrons are guided to the collector electrode 24 (see FIG. 1) to excite the fluorescent layer 28 to emit fluorescent light from the fluorescent layer 28 to the outside. Some of the emitted electrons are guided to the anode electrode 20.

As shown in FIG. 5A, when the emitted electrons are guided to the anode electrode 20, the gas near the anode electrode 20 and floating atoms (generated by evaporation of the electrode) near the anode electrode 20 are ionized into positive ions and electrons by the emitted electrons. The electrons generated by the ionization ionize the gas and the atoms of the electrode. Therefore, the electrons are increased exponentially to generate a local plasma 32 in which the electrons and the positive ions are neutrally present.

As shown in FIG. 5B, the electrons guided to the anode electrode 20 impinge upon the electric field receiving member 14 for causing emission of secondary electrons. As described above, some of the secondary electrons are guided to the collector electrode 24 (see FIG. 1) to excite the fluorescent layer 28 to emit fluorescent light from the fluorescent layer 28 to the outside. Some of the secondary electrons are guided to the anode electrode 20. The gas near the anode electrode 20 and floating atoms (generated by evaporation of the electrode) near the anode electrode 20 are ionized into positive ions and electrons by the emitted electrons.

Next, tree specific examples of the electron emitter 10 according to the embodiment of the present invention will be described. An electron emitter 10a according to a first specific example has substantially the same structure as the electron emitter 10 according to the embodiment described above, but differs from the electron emitter 10 in that the electric field receiving member 14 is made of a piezoelectric material.

A method of emitting electrons from the electron emitter 10a according to the first specific example will be described.

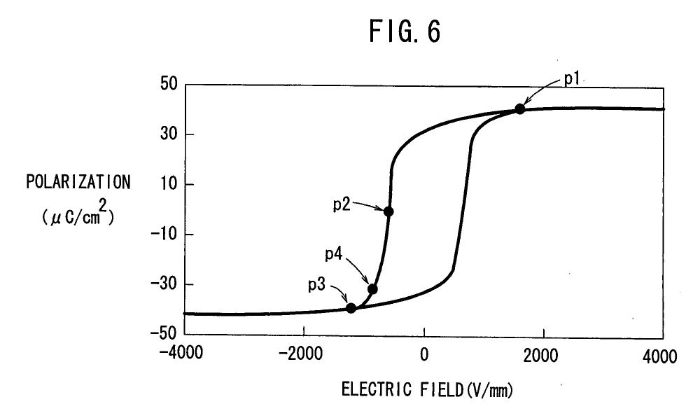

FIG. 6 shows a polarization-electric field characteristic curve of the piezoelectric material of the electric field receiving member 14. In FIG. 6, a hysteresis loop is shown around a level where the electric field E=0 V/mm).

The hysteresis loop from a point p1, a point p2, to a point p3 will be described. When a positive electric field is applied to the piezoelectric material at the point p1, the piezoelectric material is polarized substantially in one direction. Thereafter, when the electric field is negatively increased to a level of a coercive field (about −700V/mm) at the point p2, polarization reversal starts to occur. At the point p3, polarization reversal is carried out completely.

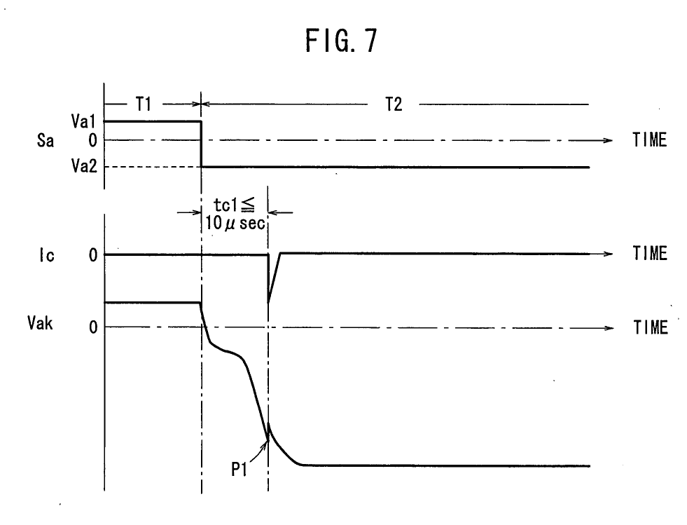

In the first specific example, as shown in FIG. 7, a positive voltage Val is applied to the cathode electrode 16, and a positive electric field (about 1000V/mm) is applied to the electric field receiving member 14 in the preparatory period T1. At this time, as shown in the polarization-electric field characteristic curve in FIG. 6, the electric field receiving member 14 is polarized in one direction.

Thereafter, in the electron emission period T2 shown in FIG. 7, a negative voltage Va2 is applied to the cathode electrode 16, for rapidly changing the electric field to a level (e.g., about −1000V/mm) beyond the level of the coercive field, electron emission starts to occur at the point p4, before the point p3 shown in FIG. 6. As shown in FIG. 7, within a certain period tc1 (10 μsec or less in this example) from the beginning of the electron emission period T2, at a the time P1 when the voltage Vak between the cathode electrode 16 and the anode electrode 20 is a peak, small voltage drop occurs. The electron emission occurs at the time P1 (peak). At the time P1 (peak), a current (collector current Ic) flows the collector electrode 24 rapidly, i.e., the emitted electrons are collected by the collector electrode 24.

As described above, the negative voltage Va2 is applied to the cathode electrode 16, for causing electron emission from the electric field concentration point A or the interface between the cathode electrode 16 and the anode electrode 14.

After the electron emission, the voltage Vak between the cathode electrode 16 and the anode electrode 20 is increased again by the negative voltage Va2 applied to the cathode electrode 16. However, since the voltage drop at the time of the electron emission is small (about 20V), the electron emission does not occur after the first electron emission.

In the method of emitting electrons from the electron emitter 10a according to the first specific example, the electric field beyond the level of the coercive field is rapidly applied to the electric field receiving member 14 which is polarized in one direction. Therefore, the electrons are emitted efficiently, and the electron emitter 10a can be utilized easily in displays or light sources.

The electric field for inducing electron emission (the electric field at the point p4) is beyond the level of the coercive field. In the electric field for electron emission, the polarization reversal is almost completed. The levels of the electric fields do not change substantially. Therefore, the electron emitter 10a has digital-like electron emission characteristics. The level of the electric field for electron emission depends on the coercive field. When the level of the coercive field is small, the electron emitter can be operated at a low voltage.

In the electron emission method, the level of the negative voltage Va2 applied to the cathode electrode 16 is controlled for applying an electric field beyond the level of the coercive field to the electric field receiving member 14 within a certain period (e.g., 10 μsec or less) from the beginning of the electron emission period T2.

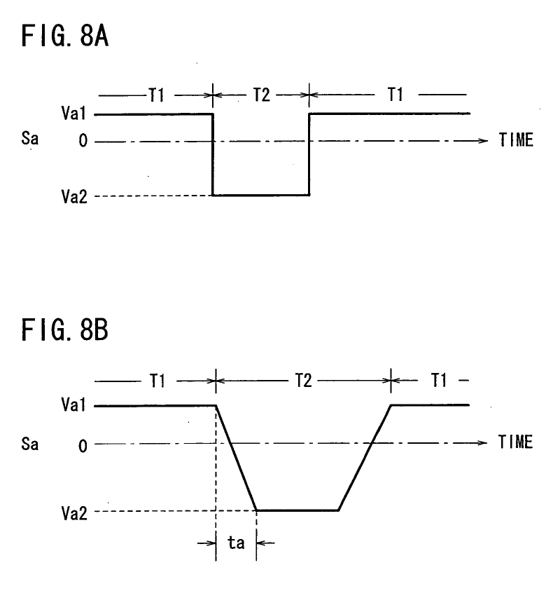

In this case, the level of the negative voltage Va2 is controlled by controlling the pulse drive signal Sa. Specifically, if the drive signal Sa has a rectangular pulse waveform as shown in FIG. 8A, the maximum amplitude (=Va2) is controlled, and if the drive signal Sa has a pulse waveform having a falling edge (ramp), for example, the maximum amplitude (=Va2) or a transition time ta (a period from the beginning of the electron emission period T2 until the voltage reaches the maximum amplitude) is controlled.

In the electron emitter 10a according to the first specific example, if the electron emission needs to be repeated, a signal having an alternating signal including positive and negative pulses can be used for carrying out the successive electron emissions easily.

Next, an electron emitter 10b according to a second specific example will be described. The electron emitter 10b according to the second specific example has substantially the same structure as the electron emitter 10 according to the embodiment described above, but differs from the electron emitter 10 in that the electric field receiving member 14 is made of an anti-ferroelectric material.

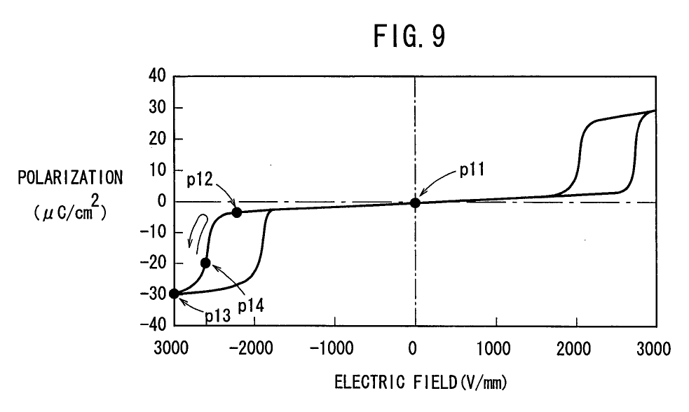

A method of emitting electrons from the electron emitter 10b according to the second specific example will be described. As shown in FIG. 9, the polarization of the anti-ferroelectric material is induced proportionally to the voltage in a small electric field. In a large electric field beyond a certain level, the anti-ferroelectric material functions as a ferroelectric material (electric field induced phase transition). Hysteresis loops are shown in the positive electric field and the negative electric field. When application of the electric field is stopped, the anti-ferroelectric material functions as a dielectric material (polarization is reset).

The hysteresis loop in the negative electric field from a point p11, a point p12, to a point p13 will be described. The anti-ferroelectric material functions as a dielectric material at the point p11 where the electric field is zero, and the polarization is reset. Then, when the negative electric field is applied, a phase transition occurs in the electric field receiving member 14, and the electric field receiving member 14 functions as a ferroelectric material. When the electric field is negatively increased beyond a level of about −2300V/mm at the point p12, polarization of the electric field receiving member 14 is started. At the point p13, the electric field receiving member 14 is polarized in one direction.

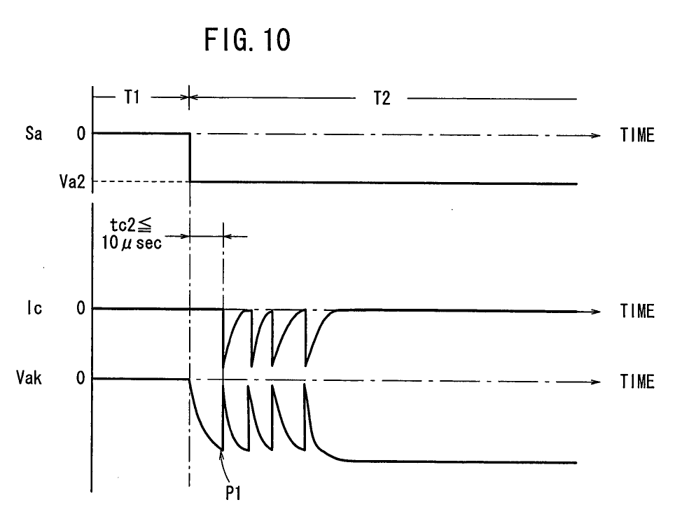

In the second specific example, as shown in FIG. 10, a reference voltage (0V) is applied to the cathode electrode 16 in the preparatory period T1. No electric field is applied to the electric field receiving member 14. At this time, as shown in the polarization-electric field characteristic curve, the polarization of the electric field receiving member 14 is reset.

Thereafter, in the electron emission period T2, a negative voltage Va2 is applied to the cathode electrode 16 for rapidly applying an electric field (e.g., about −2700V/mm) to the electric field receiving member 14 to polarize the electric field receiving member 14. At a point p14 before the point p13 shown in FIG. 9, electron emission starts to occur.

As shown in FIG. 10, within a certain period tc2 (10 μsec or less in this example) from the beginning of the electron emission period T2, at a time P1 when the voltage Vak between the cathode electrode 16 and the anode electrode 20 is a peak, a voltage drop occurs. The electron emission occurs at the time P1 (peak). At the time P1 (peak), a current (collector current Ic) flows the collector electrode 24 rapidly, i.e., the emitted electrons are collected by the collector electrode 24.

When the phase transition from the anti-ferroelectric material to the ferroelectric material occurs, the difference between the electric field for inducing electron emission (the electric field at the point p14) and the electric field for resetting polarization (the electric field at the point p12) is small. Therefore, when electron emission occurs to cause the voltage drop between the cathode electrode 16 and the anode electrode 20, the polarization in the electric field receiving member 14 is reset easily, and the electric field receiving member 14 is brought into a condition as if the electric field receiving member 14 were in the preparatory period T1 (a condition in which the reference voltage is applied).

In the electron emission period T2, since the negative voltage Va2 is applied to the cathode electrode 16, the voltage Vak between the cathode electrode 16 and the anode electrode 20 rapidly reaches the voltage level required for electron emission, and the electron emission starts to occur again.

Therefore, by continuously applying the negative voltage Va2 in the electron emission period, the above sequential operation is repeated successively. By controlling the level of the negative voltage Va2, the number of the operations can be controlled. In the example of FIG. 10, electrons are emitted four times successively.

As described above, in the method of emitting electrons from the electron emitter 10b according to the second specific example, the electric field is applied to the electric field receiving member 14 rapidly for causing phase transition in the electric field receiving member 14 into a ferroelectric material and polarization of the electric field receiving member 14. Therefore, the electrons are emitted efficiently, and the electron emitter lob can be utilized easily in displays or light sources.

In the electric field for inducing electron emission (the electric field at the point p14), polarization or polarization reversal is almost completed. The levels of the electric fields do not change substantially. Therefore, the electron emitter 10b has digital-like electron emission characteristics. The electric field for electron emission depends on the electric field for inducing phase transition of the electric field receiving member 14 into the ferroelectric material. When the level of the electric field for inducing phase transition is small, the electron emitter is operated at a low voltage.

In the electron emission method, the reference voltage applied in the preparatory period T1 is 0V. Therefore, the polarization of the electric field receiving member 14 in the preparatory period T1 is reset. Electron emission in the electron emission period T2 can be carried out by the single polarity operation (negative polarity). Thus, the driving circuit system is simplified. The electron emitter can be operated by small energy consumption at a low cost with a compact structure.

The level (the maximum amplitude or phase transition period ta) of the negative voltage Va2 applied to the cathode electrode 16 is controlled for applying an electric field to induce the phase transition of the electric field receiving member 14 within a certain period (e.g., 10 μsec or less) from the beginning of the electron emission period T2, and polarize the electric field receiving member 14.

Next, an electron emitter 10c according to a third specific example will be described. The electron emitter 10c according to the third specific example has substantially the same structure as the electron emitter 10 according to the embodiment described above, but differs from the electron emitter 10 in that the electric field receiving member 14 is made of an electrostrictive material.

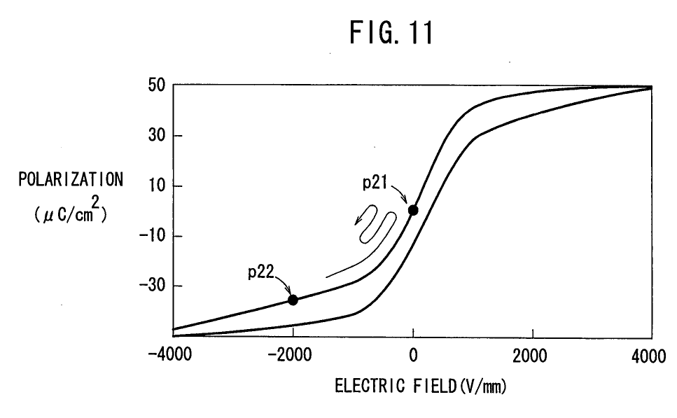

A method of emitting electrons from the electron emitter 10c according to the third specific example will be described. As shown in FIG. 11, the polarization of the electrostrictive material is induced substantially proportionally to the electric field. The rate of change in the polarization is large in a small electric field in comparison with a large electric field. The polarization occurs gradually according to the change of the electric field. When no electric field is applied, the polarization is reset.

The hysteresis loop from a point p21 to a point p22 will be described. The polarization of the electrostrictive material is reset at the point p21. Then, when a negative electric field is applied, the electric field receiving member 14 is polarized according to the applied electric field.

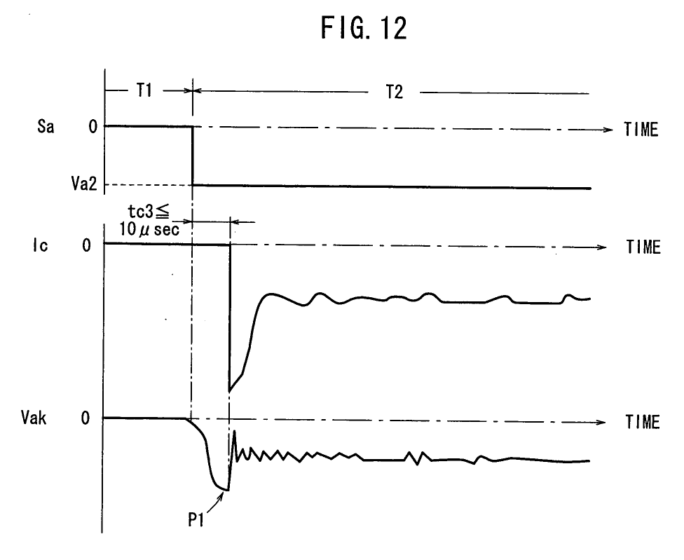

In the third specific example, as shown in FIG. 12, a reference voltage (0V) is applied to the cathode electrode 16 in the preparatory period T1. No electric field is applied to the electric field receiving member 14. At this time, as shown in the polarization-electric field characteristic curve, the polarization of the electric field receiving member 14 is reset.

Thereafter, in the electron emission period T2, a negative voltage Va2 is applied to the cathode electrode 16 for rapidly applying an electric field (e.g., about −2000V/mm) to the electric field receiving member 14 to polarize the electric field receiving member 14. At the point p22, electron emission starts to occur. As shown in FIG. 12, within a certain period tc3 (10 μsec or less in this example) from the beginning of the electron emission period T2, at a time P1 when the voltage Vak between the cathode electrode 16 and the anode electrode 20 is a peak, a voltage drop occurs. The electron emission occurs at the time P1 (peak). At the time P1 (peak), a current (collector current Ic) flows the collector electrode 24 rapidly, i.e., the emitted electrons are collected by the collector electrode 24.

In the electron emitter 10c according to the third specific example, the electric field receiving member 14 is polarized gradually according to the change of the electric field. When the amount of polarization per unit time is large (when the change of the electric field within the certain period is large), the number of emitted electrons is large.

The number of emitted electrons depends on the intensity in the electric field to some extent. However, the number of emitted electrons depends more largely depends on the change in the intensity of the electric field. As long as the change in the intensity of the electric field is large, even if the electric field is small, the number of emitted electrons is large. Therefore, the electron emitter 10c has analog-like electron emission characteristics.

The potential difference between the electric field for inducing electron emission (the electric field at the point p22) and the electric field for resetting polarization (the electric field at the point p21) is small. Therefore, when electron emission occurs to cause the voltage drop between the cathode electrode 16 and the anode electrode 20, the polarization in the electric field receiving member 14 is reset easily, and the electric field receiving member 14 is brought into a condition as if the electric field receiving member 14 were in the preparatory period T1 (a condition in which the reference voltage is applied).

In the electron emission period T2, the negative voltage Va2 is applied to the cathode electrode 16. Therefore, the voltage between the cathode electrode 16 and the anode electrode 20 is increased rapidly. At this time, the change in the polarization progresses rapidly. Thus, the electrons are emitted at a voltage lower than the voltage for the first electron emission.

After the second electron emission to cause the voltage drop between the cathode electrode 16 and the anode electrode 20, the polarization of the electric field receiving member 14 is reset again easily. Thereafter, by continuously applying the negative voltage Va2 to the cathode electrode 16, the voltage Vak between the cathode electrode 16 and the anode electrode 20 is increased again to polarize the electric field receiving member 14. Again, the change in the polarization progresses rapidly, and the electron emission occurs at a voltage substantially same as the voltage for the second electron emission.

After the first electron emission, the voltage Vak between the cathode electrode 16 and the anode electrode 20 fluctuates slightly. The slight fluctuation keeps the electron emission. By controlling the level of the negative voltage Va2, it is possible to control the duration of the electron emission.

As described above, in the method of emitting electrons from the electron emitter 10c according to the third specific example, the rate of change in the electric field applied to the electric field receiving member 14 per unit time is controlled for controlling the amount of polarization in the electric field receiving member 14. Therefore, the electrons are emitted efficiently, and the electron emitter 10c can be utilized easily in displays or light sources.

As described above, when the change in the intensity of the electric field per unit time (the rate of change in the polarization per unit time) is large, the intensity of the electric field can be small. Therefore, the electron emitter can be operated at a low voltage.

In the electron emission method, the reference voltage applied in the preparatory period T1 is 0V. Therefore, the polarization of the electric field receiving member 14 in the preparatory period T1 is reset. Electron emission in the electron emission period T2 can be carried out by the single polarity operation (negative polarity). Thus, the driving circuit system is simplified. The electron emitter can be operated by small energy consumption at a low cost with a compact structure.

The level (the maximum amplitude or phase transition period ta) of the negative voltage Va2 applied to the cathode electrode 16 is controlled for applying an electric field to control the amount of polarization in the electric field receiving member 14 within a certain period tc3 (e.g., 10 μsec or less) from the beginning of the electron emission period T2 and controlling the electron emission.

In the electron emitter 10 according to the embodiment of the present invention (including the electron emitter 10a through 10c according to the first through third specific examples), the collector electrode 24 is coated with the fluorescent layer 28 for use as a pixel of a display as shown in FIG. 1. The displays of the electron emitter 10 offer the following advantages:

(1) The displays can be thinner (the panel thickness=several mm) than CRTs.

(2) Since the displays emit natural light from the fluorescent layer 28, they can provide a wide angle of view which is about 1800 unlike LCDs (liquid crystal displays) and LEDs (light-emitting diodes).

(3) Since the displays employ a surface electron source, they produce less image distortions than CRTs.

(4) The displays can respond more quickly than LCDs, and can display moving images free of after image with a high-speed response on the order of μsec.

(5) The displays consume an electric power of about 100 W in terms of a 40-inch size, and hence is characterized by lower power consumption than CRTs, PDPs (plasma displays), LCDS, and LEDs.

(6) The displays have a wider operating temperature range (−40 to +85° C.) than PDPs and LCDs. LCDs have lower response speeds at lower temperatures.

(7) The displays can produce higher luminance than conventional FED displays as the fluorescent material can be excited by a large current output.

(8) The displays can be driven at a lower voltage than conventional FED displays because the drive voltage can be controlled by the polarization reversing characteristics and film thickness of the piezoelectric material.

Because of the above various advantages, the displays can be used in a variety of applications described below.

(1) Since the displays can produce higher luminance and consume lower electric power, they are optimum for use as 30- through 60-inch displays for home use (television and home theaters) and public use (waiting rooms, karaoke rooms, etc.).

(2) In as much as the displays can produce higher luminance, can provide large screen sizes, can display full-color images, and can display high-definition images, they are optimum for use as horizontally or vertically long, specially shaped displays, displays in exhibitions, and message boards for information guides.

(3) Because the displays can provide a wider angle of view due to higher luminance and fluorescent excitation, and can be operated in a wider operating temperature range due to vacuum modularization thereof, they are optimum for use as displays on vehicles. Displays for use on vehicles need to have a horizontally long 8-inch size whose horizontal and vertical lengths have a ratio of 15:9 (pixel pitch=0.14 mm), an operating temperature in the range from −30 to +85° C., and a luminance level ranging from 500 to 600 cd/m² in an oblique direction.

Because of the above various advantages, the electron emitters can be used as a variety of light sources described below.

(1) Since the electron emitters can produce higher luminance and consume lower electric power, they are optimum for use as projector light sources which are required to have a luminance level of 200 lumens. In the case of carbon nanotube lamp, the luminance level is 104 cd/m² (160 lumens) when operated at an anode voltage 10 kV, an anode current 300 μA, on a fluorescent surface having a diameter of 27 mm. Therefore, the required luminance level for projector light sources is ten times higher than the luminance level of the carbon nanotube lamp. Therefore, it is difficult to use the carbon nanotube lamp as the projector light source.

(2) Because the electron emitters can easily provide a high-luminance two-dimensional array light source, can be operated in a wide temperature range, and have their light emission efficiency unchanged in outdoor environments, they are promising as an alternative to LEDs. For example, the electron emitters are optimum as an alternative to two dimensional array LED modules for traffic signal devices. At 25° C. or higher, LEDs have an allowable current lowered and produce low luminance.

The method of emitting electrons from the electron emitter according to the present invention is not limited to the above embodiments, but may be embodied in various arrangement without departing from the scope of the present invention.

What is claimed is:

1. A method of emitting electrons from an electron emitter including an electric field receiving member made of a piezoelectric material, a cathode electrode in contact with said electric field receiving member, and an anode electrode in contact with said electric field receiving member, said method comprising the steps of:
polarizing said electric field receiving member in one direction; and
applying an electric field beyond a coercive field rapidly to said electric field receiving member to reverse polarization of said electric field receiving member for emitting electrons.

2. A method of emitting electrons according to claim 1, wherein said electric field beyond said coercive field is applied to said electric field within a certain period for emitting electrons.

3. A method of emitting electrons according to claim 1, wherein said polarization of said electric field receiving member in one direction is performed by applying a voltage between said cathode electrode and said anode electrode for causing said cathode electrode to have a positive potential in a first period, and
said polarization reversal of said electric field receiving member for emitting electrons is performed by applying a voltage between said cathode electrode and said anode electrode for causing cathode electrode to have a negative potential in a second period.

4. A method of emitting electrons according to claim 3, wherein a level of said voltage for causing said cathode electrode to have said negative potential is controlled so that said electric field beyond said coercive field is applied to said electric field for emitting electrons within a certain period from the beginning of said second period.

5. A method of emitting electrons from an electron emitter including an electric field receiving member made of an anti-ferroelectric material, a cathode electrode in contact with said electric field receiving member, and an anode electrode in contact with said electric field receiving member, said method comprising the step of:
applying an electric field to said electric field receiving member to induce phase transition of said electric field receiving member into a ferroelectric material, and polarize said electric field receiving member for emitting electrons.

6. A method of emitting electrons according to claim 5, wherein said electric field applied to said electric field receiving member has a level for inducing phase transition of said electric field receiving member within a certain period, and polarizing said electric field receiving member for emitting electrons.

7. A method of emitting electrons according to claim 5, wherein phase transition of said electric field receiving member is induced, and said electric field receiving member is polarized for emitting electrons by the steps of:
applying a reference voltage between said cathode electrode and said anode electrode in a first period; and
applying a voltage rapidly between said cathode electrode and said anode electrode to cause said cathode electrode to have a negative potential in a second period.

8. A method of emitting electrons according to claim 7, wherein said reference voltage is 0 V.

9. A method of emitting electrons according to claim 7, wherein a level of said voltage for causing said cathode electrode to have said negative potential is controlled so that phase transition of said electric field receiving member is induced within a certain period from the beginning of said second period, and said electric field receiving member is polarized for emitting electrons.

10. A method of emitting electrons according to claim 7, wherein a level of said voltage for causing said cathode electrode to have said negative potential is controlled at the beginning of said second period to repeat a series of cycle in which said voltage between said electrode and said anode electrode reaches a level required for electron emission and said voltage between said cathode electrode and said anode electrode drops due to electron emission to a threshold level for resetting polarization of said electric field receiving member.

11. A method of emitting electrons from an electron emitter including an electric field receiving member made of an electrostrictive material, a cathode electrode in contact with said electric field receiving member, and an anode electrode in contact with said electric field receiving member, said method comprising the step of:
applying an electric field to said electric field receiving member to control the amount of polarization of said electric field receiving member for emitting electrons.

12. A method of emitting electrons according to claim 11, wherein said electric field receiving member is polarized for emitting electrons by the steps of:
applying a reference voltage between said cathode electrode and said anode electrode in a first period; and
applying a voltage rapidly between said cathode electrode and said anode electrode to cause said cathode electrode to have a negative potential in a second period.

13. A method of emitting electrons according to claim 12, wherein said reference voltage is 0 V.

14. A method of emitting electrons according to claim 12, wherein a level of said voltage for causing said cathode electrode to have said negative potential is controlled so that an amount of polarization in the electric field receiving member within a certain period from the beginning of said second period is controlled, and the number of emitted electrons is controlled.

15. A method of emitting electrons according to claim 12, wherein a level of said voltage for causing said cathode electrode to have said negative potential is controlled at the beginning of said second period so that electron emission continues after said electron emission by slight fluctuation of said voltage between said cathode electrode and said anode electrode.
